(19) United States
(12) Patent Application Publication
(10) Pub. No.: US 2008/0095175 A1
(43) Pub. Date: Apr. 24, 2008

(54) HSPA PROTOCOL AND ARCHITECTURE

(75) Inventors: Sudheer A. Grandhi, Mamaroneck, NY (US); Stephen E. Terry, Northport, NY (US); James M. Miller, Verona, NJ (US); Diana Pani, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/875,457

(22) Filed: Oct. 19, 2007

Related U.S. Application Data
(60) Provisional application No. 60/862,122, filed on Oct. 19, 2006.
(60) Provisional application No. 60/883,441, filed on Jan. 4, 2007.

(51) Int. Cl. H04L 12/28

(52) U.S. Cl. 370/395.52

(57) ABSTRACT

A high speed packet access (HSPA) protocol architecture includes an HSPA NodeB, an HSPA radio network controller (RNC), and a core network. The HSPA NodeB includes a user plane (UP)/control plane (CP) transmit (Tx) lower radio link controller (RLC) functional layer, a UP/CP receive (Rx) lower RLC functional layer, a medium access control (MAC) functional layer, and a physical layer. The HSPA RNC includes a radio resource controller (RRC) functional layer, a packet data convergence protocol (PDCP) functional layer, a UP/CP Tx upper RLC functional layer, a UP/CP Rx upper RLC functional layer, and a physical layer. The HSPA NodeB is in communication with the HSPA RNC and the HSPA RNC is in communication with the core network.

### CROSS REFERENCE TO RELATED APPLICATIONS

This application claims the benefit of U.S. Provisional Application Nos. 60/862,122, filed Oct. 19, 2006 and 60/883,441, filed Jan. 4, 2007, which are incorporated herein by reference as if fully set forth.

### FIELD OF INVENTION

The present invention is related to wireless communication systems.

### BACKGROUND

The high speed packet access (HSPA) and HSPA+ evolution of the third generation partnership project (3GPP) high speed data packet access (HSDPA) and high speed uplink packet access (HSUPA) is intended to provide higher data rates, higher system capacity and coverage, enhanced support for packet services, reduced latency, reduced operator costs and backward compatibility. The current radio interface protocol and network architecture are not conducive to facilitating the HSPA and HSPA+ evolution.

The following definitions apply throughout:
ARQ—Automatic Repeat Request
CN—Core Network
CP—Control Plane
CS—Circuit Switched
DL—Down Link
HARQ—Hybrid Automatic Repeat Request
IP—Internet Protocol
LCID—Logical Channel Identifier
LTE—Long Term Evolution
MAC—Medium Access Control
PDCP—Packet Data Convergence Protocol
PS—Packet Switched
RAN—Radio Access Network
RLC—Radio Link Control
RoHC—Robust Header Compression
RRC—Radio Resource Control
RRM—Radio Resource Management
SAP—Service Access Point
SDU—Service Data Unit
UE—User Equipment
UL—Up Link
UP—User Plane
UMTS—Universal Mobile Telecommunications System

The current UMTS architecture currently has several defined network elements (UE, Node-B, radio network controller (RNC), CN) and interfaces between the elements (Uu, Iub, Iur, Iu). The RNC and Node-B elements form the UMTS terrestrial radio access network (UTRAN). The radio interface protocols of Layer 2 in the C-plane are CP MAC and CP RLC. In the U-plane, the Layer 2 radio interface protocols are UP MAC, UP RLC, packet data convergence protocol (PDCP) and broadcast and multicast control (BMC). The Layer 3 radio interface protocol is the RRC, which belongs to the C-plane. The Layer 1 protocol is the physical layer, which is an air-interface between the Node-B and UE.

In general, legacy radio interface protocol functions are mapped to the UTRAN network elements. For example, MAC-d, (e.g., dedicated channels), RLC and RRC protocol functions are typically associated with the RNC. The physical layer and MAC-hs/e, (e.g., high speed shared/enhanced channels) functions are typically associated with the Node-B.

However, these mappings and functions may not apply in an HSPA and HSPA+ system. Accordingly, it would be beneficial to provide protocols and architecture for HSPA and HSPA+ systems.

### SUMMARY

A high speed packet access (HSPA) protocol architecture that includes an HSPA NodeB, an HSPA radio network controller (RNC), and a core network is disclosed. The HSPA NodeB includes a user plane (UP)/control plane (CP) transmit (Tx) lower radio link controller (RLC) functional layer, a UP/CP receive (Rx) lower RLC functional layer, a medium access control (MAC) functional layer, and a physical layer. The HSPA RNC includes a radio resource controller (RRC) functional layer, a packet data convergence protocol (PDCP) functional layer, a UP/CP Tx upper RLC functional layer, a UP/CP Rx upper RLC functional layer, and a physical layer. The HSPA NodeB is in communication with the HSPA RNC and the HSPA RNC is in communication with the core network.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is an example block diagram of RLC protocol functions;

FIG. 2 shows a wireless communication system including a plurality of wireless transmit/receive units (WTRUs), a Node-B, and an RNC;

FIG. 3 shows a WTRU and Node-B of FIG. 2;

FIG. 4 shows an example block diagram of a protocol architecture;

FIG. 5 is an alternative block diagram of RLC protocol functions; and

FIGS. 6-8 show example block diagrams of additional protocol architectures; and

FIGS. 9-12 show example block diagrams of protocol architectures including legacy support.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

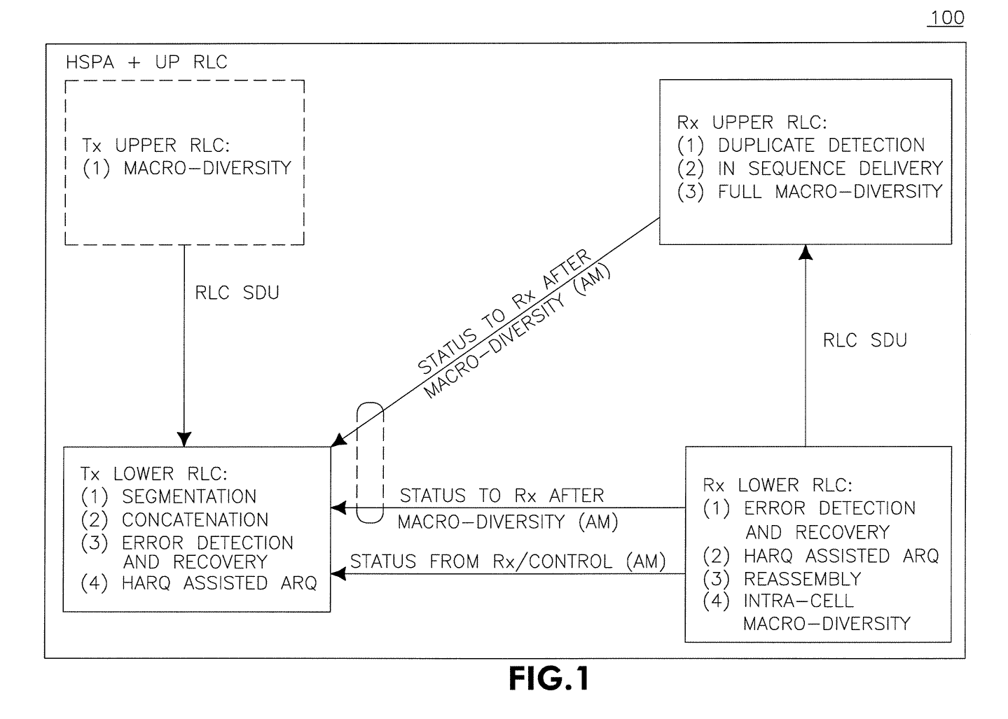

FIG. 1 shows an example block diagram 100 of RLC protocol functions. The RLC protocol is one of protocols in Layer 2 which has a big impact on the latency and throughput of data, and in the current state of the art, it is located in the RNC node. In the example shown in FIG. 1, the functions are directed toward an HSPA+UP RLC, and include a transmit (Tx) upper RLC functional block, a Tx lower RLC functional block, a receive (Rx) upper RLC functional block, and a Rx lower RLC functional block. Depending on where these functional blocks exist in the architecture, performance of a given device may vary.

Each functional block may perform typical functions. By way of example, macro-diversity may be performed in the Tx upper RLC functional block. However, macro-diversity may not be utilized in HSPA+ and is therefore optional. Some of the example functions that may be performed in the Tx lower RLC functional block are segmentation, concatenation, error detection and recovery, and hybrid automatic repeat request (HARQ) assisted ARQ.

The Rx upper RLC functional block performs, for example, duplicate detection, in sequence delivery, and full macro-diversity. Full macro-diversity may be inter-Node-B or intra-Node-B. The Rx lower RLC functional block may perform error detection and recovery, HARQ assisted ARQ, reassembly, and intra-cell macro-diversity.

In the RLC user acknowledged mode (AM) operation, (e.g., in the case of some U-plane data), the RLC protocol is bi-directional, with status and control information sent from Rx RLC to Tx RLC, that may be used for retransmission purposes. In the user transparent mode (TM) and unacknowledged mode (UM) operation, (e.g., in the case of some C-plane RRC signaling), the RLC protocol is unidirectional where the Tx RLC and Rx RLC are independent. In this case, there may be no status and control information exchange. Also, some functions, such as HARQ assisted ARQ, and error detection and recovery, may be used only in AM operation.

Example PDCP functions include header compression, data transfer, ciphering, and UP upper RLC functions. In the UP lower RLC, the function of ciphering is generally for acknowledged and unacknowledged RLC modes. In the transparent RLC mode, the ciphering may be performed in the MAC sub-layer. preferred embodiment, the ciphering function is moved to PDCP layer just as is the case of LTE technology.

Additionally, some of the functions of the MAC protocol include channel mapping, multiplexing, quality of service (QoS), link adaptation, and HARQ. QoS may include priority, scheduling, and rate control functionality, and link adaptation may be associated with QoS and multiplexing. Some of the functions of the RRC protocol include connection, mobility, and measurement.

Improvements to the current state of the art may be made by splitting the RLC protocol functions. For example, Macro-diversity functions, such as intra-Node B in the Rx lower RLC functional block, and inter-Node B in the Rx upper RLC functional block movement may be considered. Similarly, In the UP lower RLC, the function of ciphering is for acknowledged and unacknowledged RLC modes, while in the transparent RLC mode the ciphering is performed in the MAC sub-layer. Both ciphering functions may be moved to the PDCP layer. Additionally, to the Ciphering UP Upper RLC (PDCP) may take on the PDCP (Upper RLC) functions thereby eliminating the need for a separate PDCP (Upper RLC) when located in the same network element.

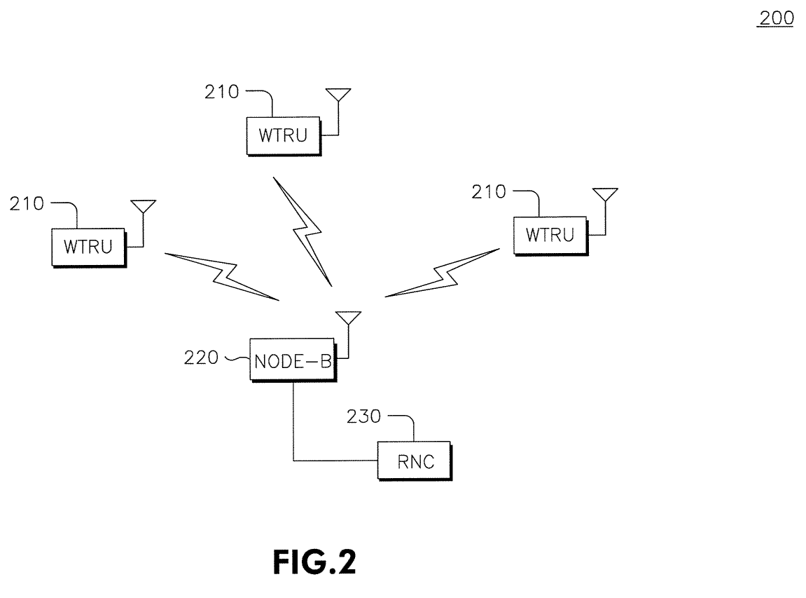

FIG. 2 shows a wireless communication system 200 including a plurality of WTRUs 210, a Node-B 220, and an RNC 230. As shown in FIG. 2, the WTRUs 210 are in communication with the Node-B 220, which is in communication with the RNC 230. Although two WTRUs 210, one Node-B 220, and one RNC 230 are shown in FIG. 2, it should be noted that any combination of wireless and wired devices may be included in the wireless communication system 200.

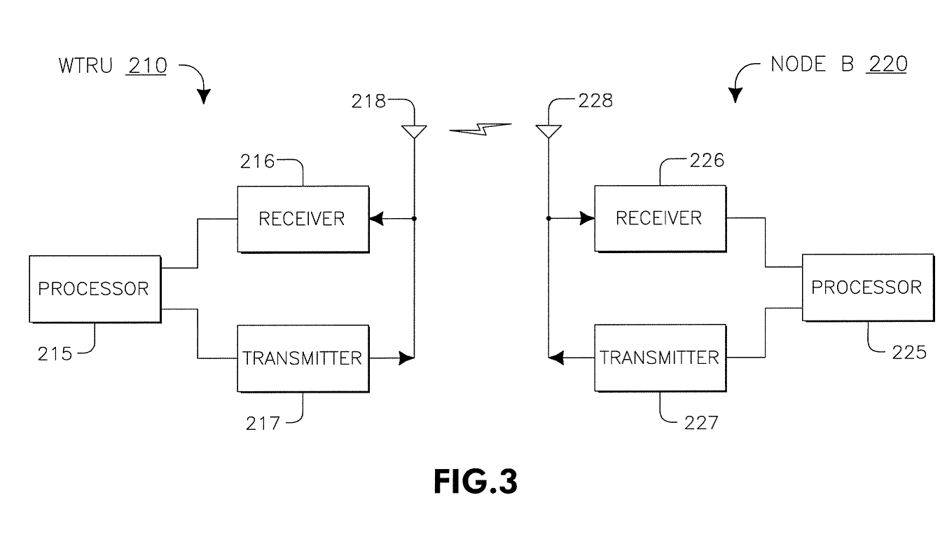

FIG. 3 is a functional block diagram 300 of a WTRU 210 and the Node-B 220 of the wireless communication system 200 of FIG. 2. As shown in FIG. 3, the WTRU 210 is in communication with the base station 220.

In addition to the components that may be found in a typical WTRU, the WTRU 210 includes a processor 215, a receiver 216, a transmitter 217, and an antenna 218. The receiver 216 and the transmitter 217 are in communication with the processor 215. The antenna 218 is in communication with both the receiver 216 and the transmitter 217 to facilitate the transmission and reception of wireless data.

In addition to the components that may be found in a typical Node-B, the Node-B 220 includes a processor 225, a receiver 226, a transmitter 227, and an antenna 228. The receiver 226 and the transmitter 227 are in communication with the processor 225. The antenna 228 is in communication with both the receiver 226 and the transmitter 227 to facilitate the transmission and reception of wireless data.

Table 1, below, shows example options for mapping radio interface protocol functions to network elements in the UTRAN architecture in Layer 2 & 3 to support HSPA+.

TABLE 1

| | HSPA + | | | | | | | | | | | |
|---|---|---|---|---|---|---|---|---|---|---|---|---|
| | Network | | UP Tx | UP Tx | UP Rx | UP Rx | CP Tx | CP Tx | CP Rx | CP Rx | | |
| Option | Elements | | Lower | Upper | Lower | Upper | Lower | Upper | Lower | Upper | | |
| No. | (UTRAN) | MAC | RLC | RLC | RLC | RLC | RLC | RLC | RLC | RLC | PDCP | RRC |
| 1a | HSPA + | | | x | | x | | | | | x | x |
| | RNC | x | x | | x | | x | x | x | x | | |
| | HSPA + | | | | | | | | | | | |
| | Node B | | | | | | | | | | | |
| 1b | HSPA + | | | x | | x | x | x | x | x | x | x |
| | RNC | x | x | | x | | | | | | | |
| | HSPA + | | | | | | | | | | | |
| | Node B | | | | | | | | | | | |
| 1c | HSPA + | | | x | | x | | x | | x | x | x |
| | RNC | x | x | | x | | x | | x | | | |
| | HSPA + | | | | | | | | | | | |
| | Node B | | | | | | | | | | | |
| 1d | HSPA + | | | x | | x | | | x | x | x | x |
| | RNC | x | x | | x | | x | x | | | | |
| | HSPA + | | | | | | | | | | | |
| | Node B | | | | | | | | | | | |
| 1e | HSPA + | | | x | | x | x | x | | | x | x |
| | RNC | x | x | | x | | | | x | x | | |
| | HSPA + | | | | | | | | | | | |
| | Node B | | | | | | | | | | | |
| 2a | HSPA + | | | | x | x | | | | | x | x |
| | RNC | x | x | x | | | x | x | x | x | | |
| | HSPA + | | | | | | | | | | | |
| | Node B | | | | | | | | | | | |
| 2b | HSPA + | | | | x | x | x | x | x | x | x | x |
| | RNC | x | x | x | | | | | | | | |
| | HSPA + | | | | | | | | | | | |
| | Node B | | | | | | | | | | | |
| 2c | HSPA + | | | | x | x | | x | | x | x | x |
| | RNC | x | x | x | | | x | | x | | | |
| | HSPA + | | | | | | | | | | | |
| | Node B | | | | | | | | | | | |
| 2d | HSPA + | | | | x | x | | | x | x | | x |
| | RNC | x | x | x | | | x | x | | | | |
| | HSPA + | | | | | | | | | | | |
| | Node B | | | | | | | | | | | |
| 2e | HSPA + | | | | x | x | x | x | | | | x |
| | RNC | x | x | x | | | | | x | x | | |
| | HSPA + | | | | | | | | | | | |
| | Node B | | | | | | | | | | | |
| 3a | HSPA + | | | | | | | | | | x | x |
| | RNC | | | | | | | | | | 4 | 4 |
| | HSPA + | x | x | x | x | x | x | x | x | x | | |
| | Node B | | | | | | | | | | | |
| 3b | HSPA + | | | | | | x | x | x | x | | x |
| | RNC | x | x | x | x | x | | | | | x | |
| | HSPA + | | | | | | | | | | 5 | |
| | Node B | | | | | | | | | | | |
| 3c | HSPA + | | | | | | | x | | x | | x |
| | RNC | x | x | x | x | x | x | | x | | x | |
| | HSPA + | | | | | | | | | | | |
| | Node B | | | | | | | | | | | |
| 3d | HSPA + | | | | | | | | x | x | | x |
| | RNC | x | x | x | x | x | x | x | | | x | |
| | HSPA + | | | | | | | | | | | |
| | Node B | | | | | | | | | | | |
| 3e | HSPA + | | | | | | x | x | | | | x |
| | RNC | x | x | x | x | x | | | x | x | x | |
| | HSPA + | | | | | | | | | | | |
| | Node B | | | | | | | | | | | |

If the PDCP and RRC functions are located at an evolved core network, the RNC element can be eliminated, since there is no RNC macro-diversity. Also, the location of the PDCP function of ciphering may be located in the packet CN. Accordingly, as shown in Table 1, there are several possibilities for the location of L2 & L3 radio interface protocol functions in the UTRAN network elements for HSPA+. Appropriate changes and enhancements would be made where necessary for the Iub, Iur and Iu interfaces.

By modifying the functions as described in Table 1, certain impacts to architecture may be apparent. For example, in the RLC, the Tx lower RLC function at the RNC 230 results in no significant change from legacy architecture, but the Tx Lower RLC function at the Node-B 220 may provide benefits with regard to latency and throughput, (e.g., retransmission, segmentation), and impacts the Iub interface in format and load. In this case, the Iub contains RLC SDUs instead of RLC packet data units (PDUs). Likewise, the Tx Upper RLC at the RNC 230 results in no significant change from legacy architecture, (i.e., no downlink macro-diversity is supported), but the Tx Upper RLC at the Node-B 220 impacts the Iub interface in format and load. Again, the Iub contains RLC SDUs instead of RLC PDUs.

The Rx lower RLC function at the RNC 230 increases latency in status/control information transfer to the Tx lower RLC function if it is located in Node-B 220. The Rx lower RLC at the Node-B 220 reduces latency in status/control information transfer to the Tx lower RLC function if it is located in Node-B 220. It also impacts Iub interface in format and load, which again contains RLC SDUs instead of RLC PDUs.

The Rx upper RLC function at the RNC 230 provides macro-diversity and power control benefits similar to legacy systems. It also impacts Iub signaling for status information sent to the Tx lower RLC function if it is located in Node-B 220 as well as providing full macro-diversity benefits. It does not impact Iub if status information is sent from the Rx Lower RLC function. Gains in inter-Node B macro-diversity in status information to a receiver may be reduced, macro-diversity gain in power control occurs.

The Rx upper RLC function at the NodeB 220 may cause a loss of macro-diversity at the inter-Node-B level, but still provides an intra-Node-B macro-diversity. Furthermore, it may reduce latency in status/control information transfer to the Tx lower RLC function if it is located in the Node-B 220. It does not impact Iub signaling for status/control information transfer to the Tx lower RLC function if it is located in Node-B 220. However, it impacts the Iub interface in format and load, with the Iub containing RLC SDUs instead of RLC PDUs.

The ciphering function of the PDCP functional layer at the RNC 230 or CN tends to increase flexibility of the RLC architecture and enhance network security. Additionally, the PDCP functional layer at the RNC 230 can be combined with the UP upper RLC function if it is also located in the RNC 230.

Additional constraints under the current scope of the HSPA evolution include that the S1 interface is not connected with HSPA and may function with the Iu interface. Also, macro-diversity may be kept. Some protocol architectures, therefore, may have some advantages over others.

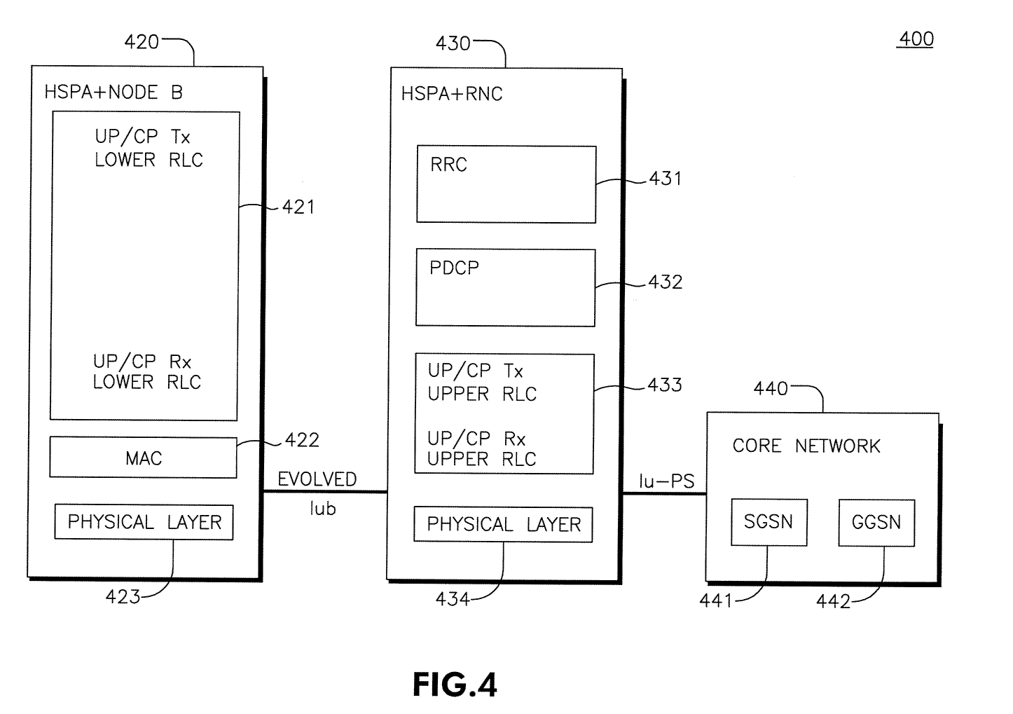

FIG. 4 shows an example block diagram of a protocol architecture 400. The protocol architecture 400 includes an HSPA+ NodeB 420, an HSPA+ RNC 430, and a core network 440. The HSPA+ NodeB 420 includes a UP/CP Tx lower RLC-UP/CP Rx lower RLC functional layer 421, a MAC layer 422 and a physical layer 423. The HSPA+ RNC 430 includes an RRC functional layer 431, a PDCP functional layer 432, a UP/CP Tx upper RLC-UP/CP Rx upper RLC functional layer 433, and a physical layer 434. The core network 440 includes a serving GPRS support node (SGSN) 441 and a gateway GPRS support node (GGSN) 442. The HSPA+ NodeB 420 is connected to the HSPA+RNC 430 via an evolved Iub interface, while the HSPA+RNC 430 is connected to the core network 440 via an Iu-ps (Iu-packet switched) interface.

In the example shown in FIG. 4, the lower RLC functions in the U-plane and C-plane are located in the HSPA+ NodeB 420. The upper RLC functions in the U-plane and C-plane are housed in the HSPA+RNC 430. Accordingly, in the protocol architecture 400, the evolved Iub interface should account for the new locations of the various protocol functions.

In the protocol architecture 400, the UP/CP Tx lower RLC function performs, for example, segmentation, concatenation, error detection and recovery, and HARQ assisted ARQ. The UP/CP Rx lower RLC function performs, for example, error detection and recovery, HARQ assisted ARQ, reassembly, and intra-cell macro-diversity.

The RRC functional layer 431 performs, for example, connection functions, mobility, and measurements. The PDCP functional layer 432 performs, for example, header compression, data transfer, and ciphering. The UP/CP Tx upper RLC function may perform macro-diversity, if desired, while the UP/CP Rx upper RLC function performs, for example, duplicate detection, in sequence delivery, and full macro-diversity.

Additionally, in the protocol architecture 400, since the ciphering function is performed in the PDCP functional layer 432, the relocation of the UP Tx lower RLC functional layer to the HSPA+ NodeB 420 is possible. Enhanced performance in latency and throughput may be achieved since the Tx lower RLC related functions are performed in the HSPA+ NodeB 420, allowing for many optimization mechanisms and procedures, such as retransmission, segmentation, and the like.

Additional effects are that CP latency may be reduced in the protocol architecture 400 since the evolved Iub interface contains RLC SDU traffic. Additionally, inter-Node B RRM can be supported at the HSPA+RNC 230. Macro-diversity can include UL soft handover as well as UL softer handover and outer loop power control may take into account UL soft handover and softer handover (macro-diversity).

A legacy Iu interface can be reused in this architecture, as well. Some of the other considerations in the protocol architecture 400 are that there may be multiple Rx RLC peers needing control signaling from a WTRU 210 to account for duplication, although selection diversity may be performed at the HSPA+RNC 430. Additionally, there may be issues regarding latency and throughput due to the PDCP functional layer 432 and UP upper RLC functional layer 433 being located in the HSPA+RNC 430.

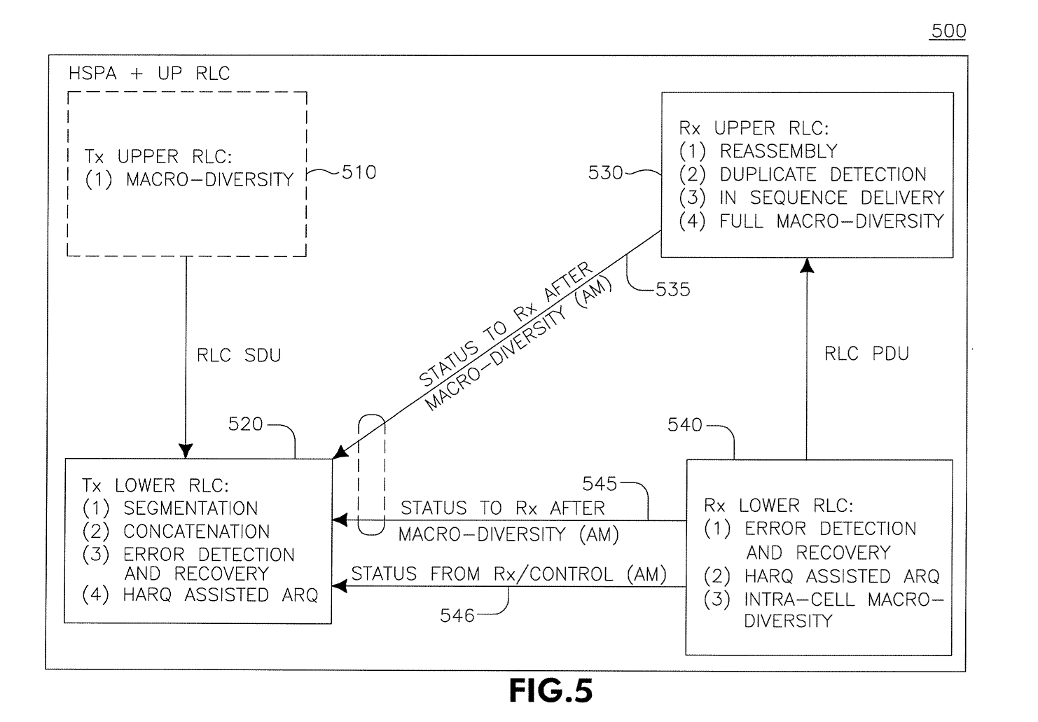

FIG. 5 is an alternative block diagram 500 of RLC protocol functions. As shown in FIG. 5, there are four RLC protocol functional layers, the Tx upper RLC functional layer 510, the Tx lower RLC functional layer 520, the Rx upper RLC functional layer 530, and the Rx lower RLC functional layer 540. The Tx upper RLC functional layer 510 performs, for example, macro-diversity, if desired. The Tx lower RLC functional layer 520 performs, for example, segmentation, concatenation, error detection and recovery, and HARQ assisted ARQ. The Rx upper RLC functional layer 530 performs, for example, reassembly, duplicate detection, in sequence delivery, and full macro-diversity. The Rx lower RLC functional layer performs, for example, error detection and recovery, HARQ assisted ARQ, and intra-cell macro-diversity. The Rx upper RLC functional layer 530 in AM sends a STATUS to Rx after macro-diversity signal 535 to the Tx lower RLC functional layer 520. The Rx lower RLC functional layer 540 transmits a STATUS to Rx after macro-diversity (AM) signal 545 and a STATUS from Rx/control (AM) signal to the Tx lower RLC functional layer 520.

Moving the reassembly function to the Rx upper RLC functional layer 530 results in a PDU based interface between the Rx lower RLC functional layer 540 and the Rx upper RLC functional layer 530. In this case, data is transferred as a PDU, before reassembly, from the Rx lower RLC functional layer 540 to the Rx upper RLC functional layer 530. Additionally, locating the reassembly function in the Rx upper RLC functional layer 530 instead of the Rx lower RLC functional layer 540 may enable more successful reassembly of SDUs from PDUs because of full macro-diversity, since the same PDUs are received by two NodeBs and transmitted to the RNC. The PDUs are reassembled to form an SDU. Since there is diversity in the PDUs, (i.e., the same PDUs are received at two NodeBs), there is an increased chance of reassembling the SDU correctly. Additionally, data is transferred over the Evolved Iub interface from the Rx lower RLC functional layer to the Rx upper RLC functional layer in the form of PDUs which may incur more overhead than SDU transmission.

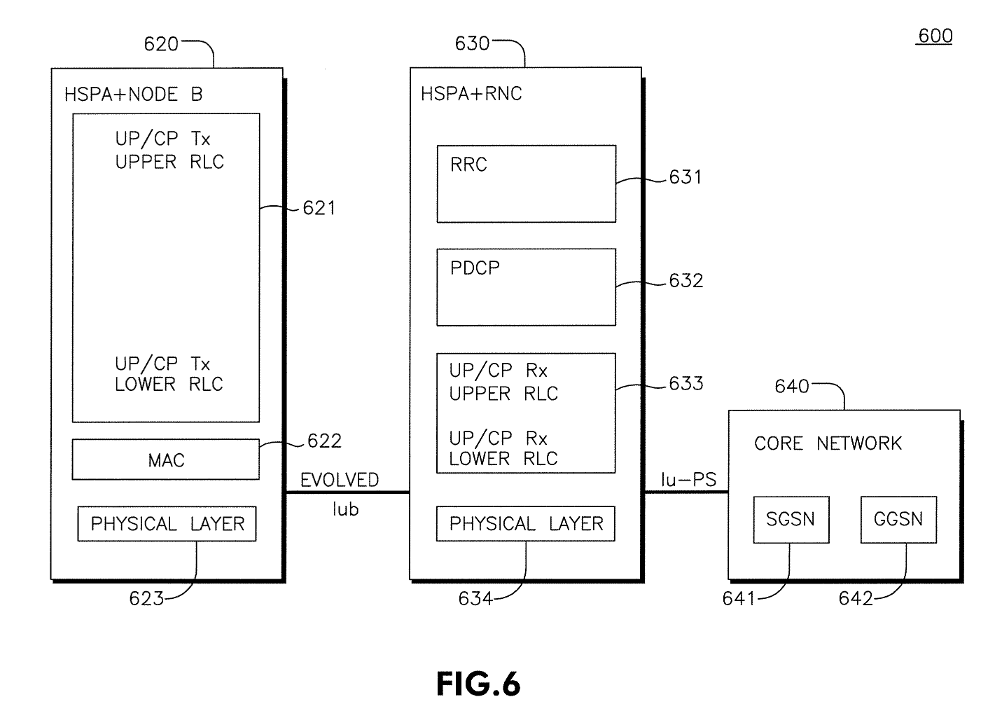

FIG. 6 shows an example block diagram of an additional protocol architecture 600. The protocol architecture 600 includes an HSPA+ NodeB 620, an HSPA+RNC 630, and a core network 640. The HSPA+ NodeB 620 includes a UP/CP Tx upper RLC-UP/CP Tx lower RLC functional layer 621, a MAC layer 622 and a physical layer 623. The HSPA+RNC 630 includes an RRC functional layer 631, a PDCP functional layer 632, a UP/CP Rx upper RLC-UP/CP Rx lower RLC functional layer 633, and a physical layer 634. The core network includes an SGSN 641 and a GGSN 642. The HSPA+ NodeB 620 is connected to the HSPA+RNC 630 via an evolved Iub interface, while the HSPA+RNC 630 is connected to the core network via an Iu-ps interface.

The protocol architecture 600 is similar to the protocol architecture 400. However in the protocol architecture 600, the functional layer 621 includes the UP/CP Tx upper RLC and UP/CP Tx lower RLC functions located in the HSPA+ NodeB 620. The functional layer 633 includes the UP/CP Rx upper RLC and UP/CP Rx lower RLC functions located in the HSPA+ RNC 630. Additionally, the RRC functional layer 631 performs connection, mobility, and measurement functions, and the PDCP functional layer 632 performs header compression, data transfer and ciphering.

In the protocol architecture 600, since the ciphering function is performed in the PDCP functional layer 632, the relocation of the UP Tx lower RLC functional layer to the HSPA+ NodeB 620 is possible. Enhanced performance in latency and throughput may be achieved since the Tx lower RLC related functions are performed in the HSPA+ NodeB 620, allowing for many optimization mechanisms and procedures, such as retransmission, segmentation, and the like.

Additional effects are that CP latency may be reduced in the protocol architecture 600 since the evolved Iub interface contains RLC SDU traffic. Additionally, inter-Node B RRM can be supported at the HSPA+ RNC 630. Macro-diversity can include UL soft handover as well as UL softer handover and outer loop power control may take into account UL soft handover and softer handover (macro-diversity).

A legacy Iu interface can be reused in this architecture, as well. Since there are no multiple Rx RLC peers in protocol architecture 600, there may be no need for control signaling from a WTRU 210 to account for duplication, although selection diversity may be performed at the HSPA+ RNC 630. Additionally, there may be issues regarding increased latency in status and control information transfer to the Tx lower RLC functional layer 621 located in the HSPA+ NodeB 620 as well as an impact to Iub signaling.

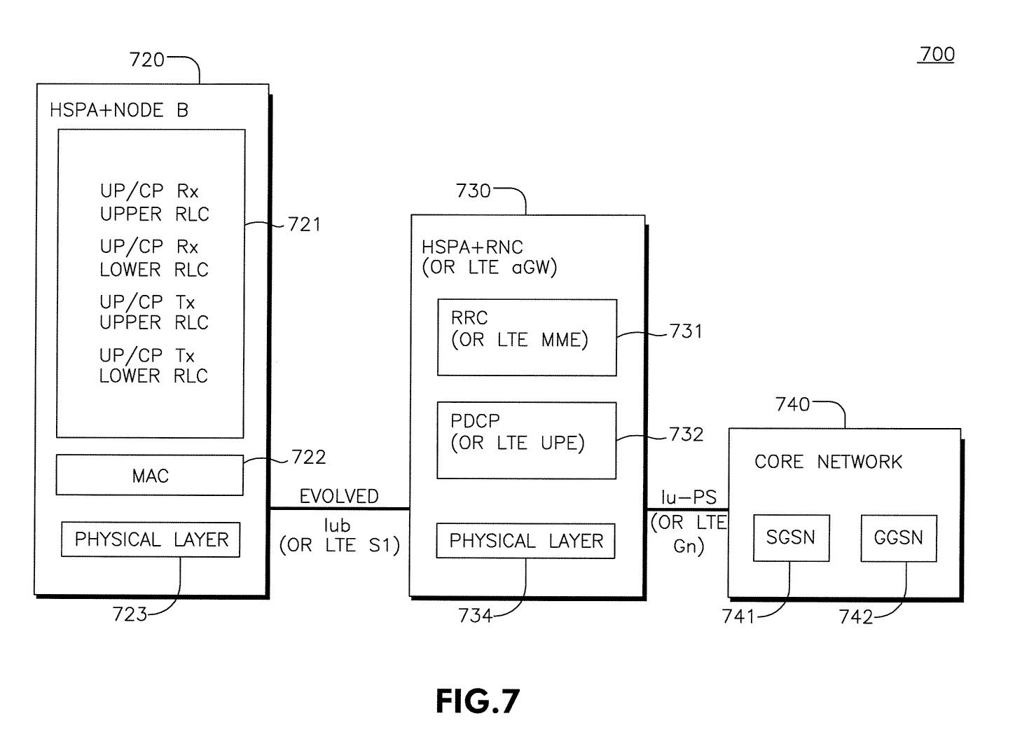

FIG. 7 shows an example block diagram of an additional protocol architecture 700. The protocol architecture 700 includes an HSPA+ NodeB 720, an HSPA+ RNC, or LTE aGW, 730, and a core network 740. The HSPA+ NodeB 720 includes a functional layer 721 that includes all RLC functions, (i.e., UP/CP Rx upper RLC, UP/CP Rx lower RLC, UP/CP Tx upper RLC, and UP/CP Tx lower RLC). Additionally, the HSPA+ NodeB 720 includes a MAC functional layer 722 and a physical layer 723.

The HSPA+ RNC/LTE aGW 730 includes an RRC functional layer 731 (or LTE mobility management entity (MME)), a PDCP functional layer 732 (or LTE user plane entity (UPE)), and a physical layer 734. The core network 740 includes an SGSN 741 and a GGSN 742. The HSPA+ NodeB 720 is connected to the HSPA+ RNC 730 via an evolved Iub interface (or LTE S1 interface), while the HSPA+ RNC 630 is connected to the core network via an Iu-ps interface (or LTE Gn interface).

In the protocol architecture 700, the UP/CP Tx lower RLC function performs, for example, segmentation, concatenation, error detection and recovery, and HARQ assisted ARQ. The UP/CP Rx lower RLC function performs, for example, error detection and recovery, HARQ assisted ARQ, reassembly, and intra-cell macro-diversity. The UP/CP Tx upper RLC function may perform macro-diversity, if desired, while the UP/CP Rx upper RLC function performs, for example, duplicate detection, in sequence delivery, and full macro-diversity.

The RRC functional layer 731 performs, for example, connection functions, mobility, and measurements. The PDCP functional layer 732 performs, for example, header compression, data transfer, and ciphering.

Additionally, in the protocol architecture 700, since the ciphering function is performed in the PDCP functional layer 732, the relocation of the UP Tx lower RLC functional layer to the HSPA+ NodeB 720 is possible. Enhanced performance in latency and throughput may be achieved since the Tx lower RLC related functions are performed in the HSPA+ NodeB 720, allowing for many optimization mechanisms and procedures, such as retransmission, segmentation, and the like.

Additional effects are that CP latency may be reduced in the protocol architecture 700 since the evolved Iub interface contains RLC SDU traffic. Additionally, inter-Node B RRM can be supported at the HSPA+ RNC 230. Macro-diversity can include UL soft handover as well as UL softer handover and outer loop power control may take into account UL soft handover and softer handover (macro-diversity).

A legacy Iu interface can be reused in this architecture, as well. Some of the other considerations in the protocol architecture 700 are that there may be multiple Rx RLC peers needing control signaling from a WTRU 210 to account for duplication, although selection diversity may be performed at the HSPA+ RNC 730.

Additionally, however, latency and throughput may be increased due to the Tx upper RLC being in HSPA+ NodeB 720. Also, there is no latency in status/control information transfer to the Tx lower RLC and no impact to Iub signaling for status/control information transfer to the Tx lower RLC located in the HSPA+NodeB 720.

Some other considerations to the protocol architecture 700 are that macro-diversity may not include a UL soft handover but may include UL softer handover. Outer loop power control may not benefit from UL soft handover, (e.g., macro-diversity), but will account for softer handover, which is considered part of macro-diversity in protocol architecture 700. Additionally, an RLC in the HSPA+ NodeB 720 may need inter-NodeB context transfers due to mobility.

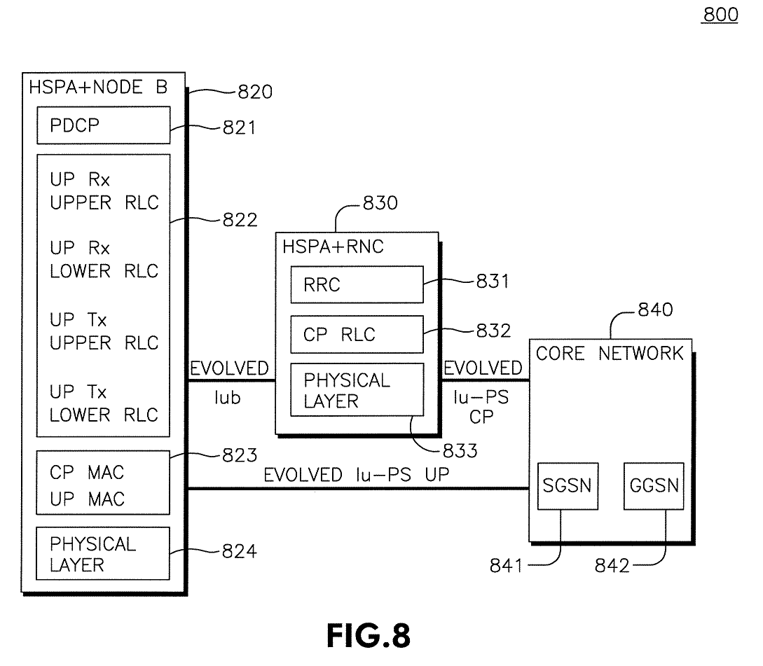

FIG. 8 shows an example block diagram of an additional protocol architecture 800. The protocol architecture 800 includes an HSPA+ NodeB 820, an HSPA+ RNC 830, and a core network 840. The HSPA+ NodeB 820 includes a PDCP functional layer 821, a functional layer 822 that includes RLC functions UP Rx upper RLC, UP Rx lower RLC, UP Tx upper RLC, and UP Tx lower RLC. Additionally, the HSPA+ NodeB 820 includes a CP/UP MAC functional layer 823 and a physical layer 824. The HSPA+ RNC 830 includes an RRC functional layer 831, a CP RLC functional layer 832 and a physical layer 833. The core network 840 includes an SGSN 841 and a GGSN 842. The HSPA+ NodeB 820 is connected to the HSPA+ RNC 830 via an evolved Iub interface, while the HSPA+ RNC 830 is connected to the core network via an evolved Iu-ps CP interface. In addition, the HSPA+ NodeB 820 is connected to the core network 840 via an evolved Iu-ps UP interface.

In the protocol architecture 800, the PDCP functional layer 821 may perform header compression, data transfer and ciphering. The UP Rx upper RLC function performs, for example, duplicate detection, in sequence delivery, and full macro-diversity. The Up Rx lower RLC function performs error detection and recovery, HARQ assisted ARQ, reassembly, and intra-cell macro-diversity. The Tx upper RLC may perform macro-diversity, if desired. The Tx lower RLC function performs segmentation, concatenation, error detection and recovery, and HARQ assisted ARQ.

The RRC functional layer 831 performs connection, mobility and measurement functions. Additionally, as shown in FIG. 8, the CP RLC function is located in the HSPA+ RNC 830. It should be noted that the ciphering function may be relocated to the core network and the CP MAC function may be located in the HSPA+ RNC 830 as well.

In this scenario, the evolved Iub contains only C-plane traffic, thus providing a possible reduction in CP latency. Additionally, since the RNC entity is bypassed, UP latency may be reduced.

Additional considerations include that the evolved Iub may need to take into account the relocation of the ciphering function in the HSPA+ NodeB 820. Additionally, the location of the ciphering function in HSPA+ NodeB 820 may include security requirement limitations, in which case the ciphering function may require relocation to a higher node, such as the core network 840. The legacy Iu interface may not be able to be reused in this architecture. There is no inter-NodeB macro-diversity possible in the U-plane in protocol architecture 800, and higher latency in the CP may occur since the CP Tx lower RLC function is located in the HSPA+ RNC 830.

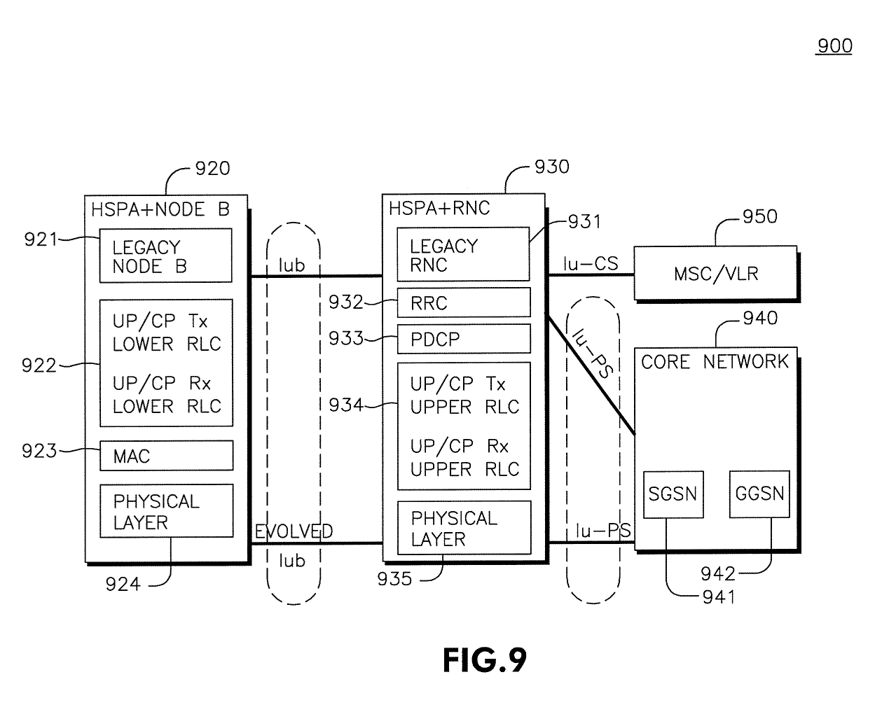

FIG. 9 shows an example block diagram of a protocol architecture 900 including legacy support. The protocol architecture 900 includes an HSPA+ NodeB 920, an HSPA+ RNC 930, a core network 940, and a mobile switching center/visitor locator register (MSC/VLR) 950. The HSPA+ NodeB 920 includes a legacy NodeB functional layer 921, a UP/CP Tx lower RLC-UP/CP Rx lower RLC functional layer 922, a MAC layer 923 and a physical layer 924. The HSPA+ RNC 930 includes a legacy RNC functional layer 931, an RRC functional layer 932, a PDCP functional layer 933, a UP/CP Tx upper RLC-UP/CP Rx upper RLC functional layer 934, and a physical layer 935. The core network 940 includes an SGSN 941 and a GGSN 942. The HSPA+ NodeB 920 is connected to the HSPA+ RNC 930 via an evolved Iub interface and a legacy Iub interface, while the HSPA+ RNC 930 is connected to the core network 940 via an Iu-ps interface, which may be an evolved Iu-ps interface, and a legacy lu-ps interface, and to the MSC/VLR 950 via an Iu-cs, (i.e., Iu-circuit switched), interface. The functionality of the protocol architecture 900 is similar to that of the protocol architecture 400, with the added support legacy operation.

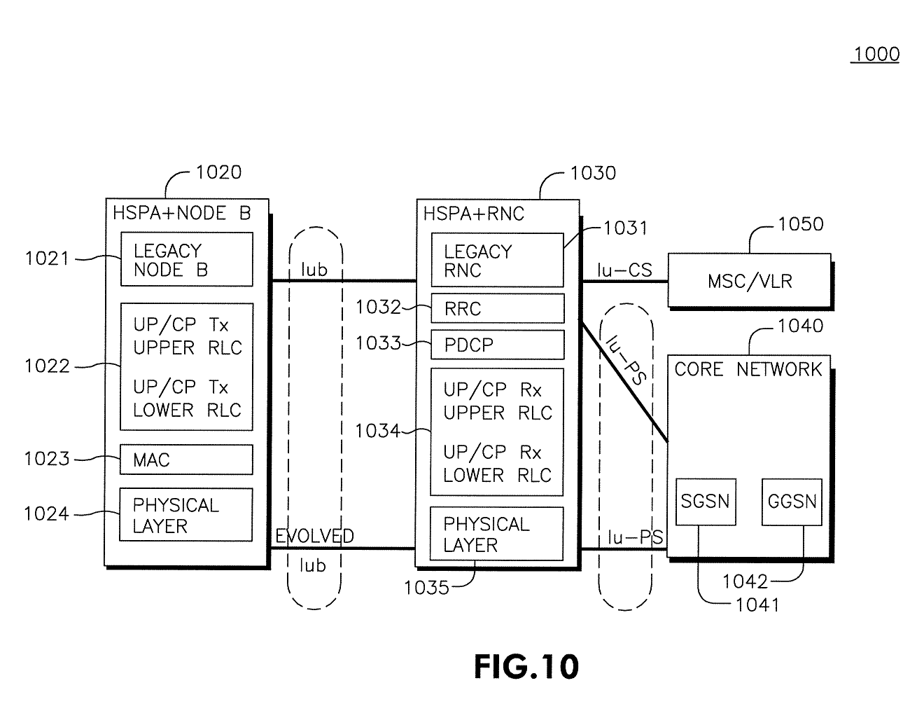

FIG. 10 shows an example block diagram of a protocol architecture 1000 including legacy support. The protocol architecture 1000 includes an HSPA+ NodeB 1020, an HSPA+ RNC 1030, a core network 1040, and an MSC/VLR 1050. The HSPA+NodeB 1020 includes a legacy NodeB functional layer 1021, a UP/CP Tx upper RLC-UP/CP Tx lower RLC functional layer 1022, a MAC layer 1023 and a physical layer 1024. The HSPA+ RNC 1030 includes a legacy RNC functional layer 1031, an RRC functional layer 1032, a PDCP functional layer 1033, a UP/CP Rx upper RLC-UP/CP Rx lower RLC functional layer 1034, and a physical layer 1035. The core network 1040 includes an SGSN 1041 and a GGSN 1042. The HSPA+ NodeB 1020 is connected to the HSPA+ RNC 1030 via an evolved Iub interface and a legacy Iub interface, while the HSPA+ RNC 1030 is connected to the core network 1040 via an Iu-ps interface, which may be an evolved Iu-ps interface, and a legacy Iu-ps interface, and to the MSC/VLR 1050 via an Iu-cs interface. The functionality of the protocol architecture 1000 is similar to that of the protocol architecture 600, with the added support for legacy operation.

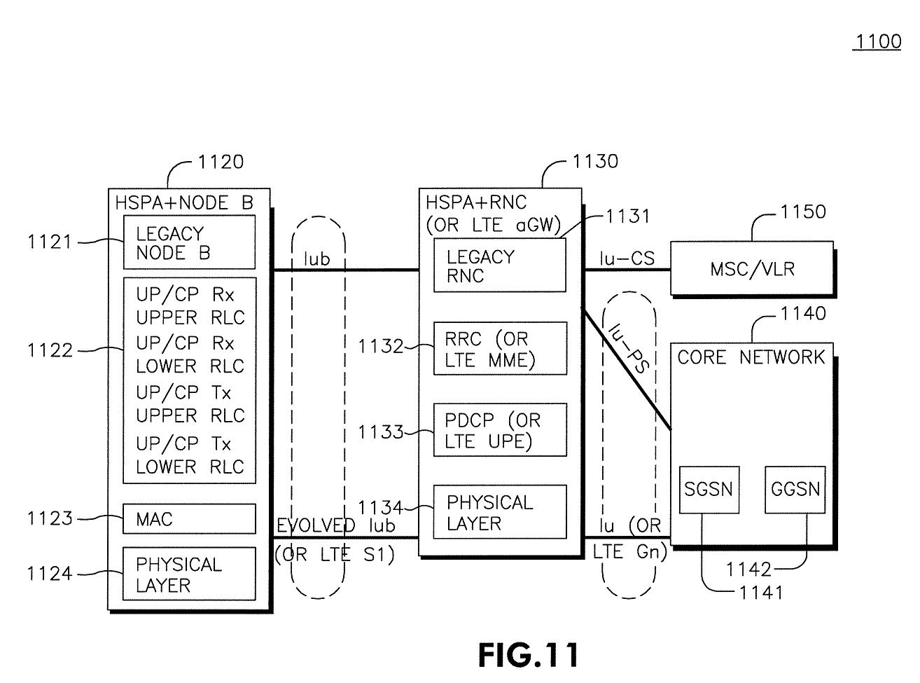

FIG. 11 shows an example block diagram of a protocol architecture 1100 including legacy support. The protocol architecture 1100 includes an HSPA+ NodeB 1220, an HSPA+ RNC 1130, a core network 1140, and an MSC/VLR 1150. The HSPA+NodeB 1120 includes a legacy NodeB functional layer 1121, and a functional layer 1122 that includes all RLC functions, (i.e., UP/CP Rx upper RLC, UP/CP Rx lower RLC, UP/CP Tx upper RLC, and UP/CP Tx lower RLC). Additionally, the HSPA+NodeB 1120 includes a MAC functional layer 1123 and a physical layer 1124.

The HSPA+ RNC/LTE aGW 1130 includes a legacy RNC functional layer 1131, an RRC functional layer 1132 (or LTE mobility management entity (MME)), a PDCP functional layer 1133 (or LTE user plane entity (UPE)), and a physical layer 1134. The core network 1140 includes an SGSN 1141 and a GGSN 1142. The HSPA+NodeB 1120 is connected to the HSPA+ RNC 1130 via an evolved Iub interface (or LTE S1 interface) and a legacy Iub interface, while the HSPA+ RNC 1130 is connected to the core network 1140 via an Iu-ps interface (or LTE Gn interface) as well as a legacy Iu-ps interface. The HSPA+ RNC 1140 is also connected to the MSC/VLR 1150 via an Iu-cs interface. The functionality of the protocol architecture 1100 is similar to that of the protocol architecture 700, with the added support for legacy operation.

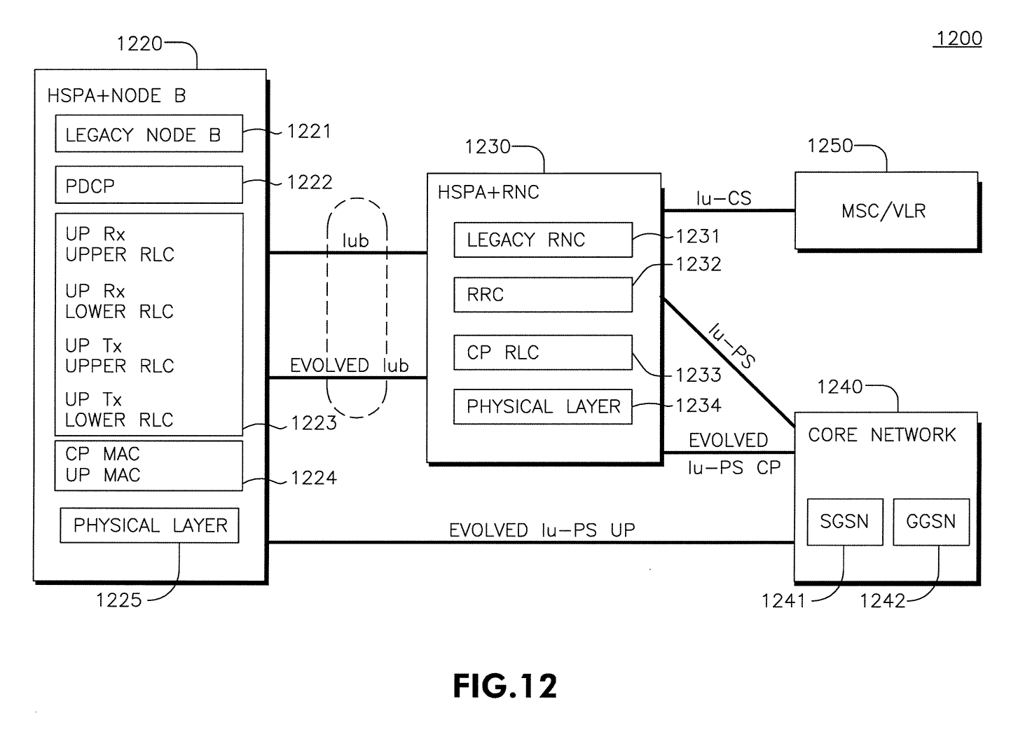

FIG. 12 shows an example block diagram of a protocol architecture 1200 including legacy support. The protocol architecture 1200 includes an HSPA+ NodeB 1220, an HSPA+ RNC 1230, a core network 1240, and an MSC/VLR 1250. The HSPA+NodeB 1220 includes a legacy NodeB functional layer 1221, a PDCP functional layer 1222, and a functional layer 1223 that includes RLC functions UP Rx upper RLC, UP Rx lower RLC, UP Tx upper RLC, and UP Tx lower RLC. Additionally, the HSPA+NodeB 1220 includes a CP/UP MAC functional layer 1224 and a physical layer 1225. The HSPA+ RNC 1230 includes a legacy RNC functional layer 1231, an RRC functional layer 1232, a CP RLC functional layer 1233 and a physical layer 1234. The core network 1240 includes an SGSN 1241 and a GGSN 1242. The HSPA+ NodeB 1220 is connected to the HSPA+ RNC 1230 via an evolved Iub interface and legacy Iub interface, while the HSPA+ RNC 1230 is connected to the core network 1240 via an evolved Iu-ps CP interface and an Iu-ps interface. In addition, the HSPA+ NodeB 1220 is connected to the core network 1240 via an evolved Iu-ps UP interface, and the HSPA+ RNC 1230 is connected to the MSC/VLR 1250 via an Iu-cs interface.

Although features and elements are described above in particular combinations, each feature or element can be used alone without the other features and elements or in various combinations with or without other features and elements. The methods or flow charts provided herein may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A high speed packet access (HSPA) NodeB, comprising:
a user plane (UP)/control plane (CP) transmit (Tx) lower radio link controller (RLC) functional layer;
a UP/CP receive (Rx) lower RLC functional layer;
a medium access control (MAC) functional layer; and
a physical layer.

2. The HSPA NodeB of claim 1 wherein the UP/CP Tx lower RLC functional layer performs any one of the following functions: segmentation, concatenation, error detection, and hybrid automatic repeat request (HARQ) assisted ARQ.

3. The HSPA NodeB of claim 1 wherein the UP/CP Rx lower RLC functional layer performs any one of the following functions: error detection and recovery, reassembly, and intra-cell macro-diversity.

4. A high speed packet access (HSPA) radio network controller (RNC), comprising:
a radio resource controller (RRC) functional layer;
a packet data convergence protocol (PDCP) functional layer;
a user plane (UP)/control plane (CP) transmit (Tx) upper radio link controller (RLC) functional layer;
a UP/CP receive (Rx) upper RLC functional layer; and
a physical layer.

5. The HSPA RNC of claim 4 wherein the RRC functional layer performs any one of the following functions: connection, mobility, and measurement.

6. The HSPA RNC of claim 4 wherein the PDCP functional layer performs any one of the following functions: header compression, data transfer, and ciphering.

7. The HSPA RNC of claim 4 wherein the UP/CP Tx upper RLC functional layer performs macro-diversity.

8. The HSPA RNC of claim 4 wherein the UP/CP Rx upper RLC functional layer performs any one of the following: duplicate detection, in sequence delivery, and full macro-diversity.

9. A high speed packet access (HSPA) protocol architecture, the protocol architecture comprising:
an HSPA NodeB, the HSPA NodeB including a user plane (UP)/control plane (CP) transmit (Tx) lower radio link controller (RLC) functional layer, a UP/CP receive (Rx) lower RLC functional layer, a medium access control (MAC) functional layer, and a physical layer;
an HSPA radio network controller (RNC), the HSPA RNC including a radio resource controller (RRC) functional layer, a packet data convergence protocol (PDCP) functional layer, a UP/CP Tx upper RLC functional layer, a UP/CP Rx upper RLC functional layer, and a physical layer; and
a core network; and wherein
the HSPA NodeB is in communication with the HSPA RNC and the HSPA RNC is in communication with the core network.

10. The HSPA protocol architecture of claim 9 wherein the HSPA NodeB communicates with the HSPA RNC over an evolved Iub interface.

11. The HSPA protocol architecture of claim 9 wherein the HSPA RNC communicates with the core network over an Iu-ps interface.

12. The HSPA protocol architecture of claim 9 wherein the core network includes a serving GPRS support node (SGSN) and a gateway GPRS support node (GGSN).

13. The HSPA protocol architecture of claim 9 wherein the UP/CP Tx lower RLC functional layer performs any one of the following functions: segmentation, concatenation, error detection, and hybrid automatic repeat request (HARQ) assisted ARQ.

14. The HSPA protocol architecture of claim 13 wherein the UP/CP Rx lower RLC functional layer performs any one of the following functions: error detection and recovery, reassembly, and intra-cell macro-diversity.

15. The HSPA protocol architecture of claim 14 wherein the PDCP functional layer performs any one of the following functions: header compression, data transfer, and ciphering.

16. The HSPA protocol architecture of claim 15 wherein the UP/CP Rx upper RLC functional layer performs any one of the following: duplicate detection, in sequence delivery, and full macro-diversity.

17. The HSPA protocol architecture of claim 16 wherein the RRC functional layer performs any one of the following functions: connection, mobility, and measurement.

18. The HSPA protocol architecture of claim 17 wherein the UP/CP Tx upper RLC functional layer performs macro-diversity.

19. The HSPA protocol architecture of claim 9 wherein the UP/CP Rx upper RLC functional layer performs reassembly.

20. The HSPA protocol architecture of claim 9 wherein the UP/CP Rx lower RLC communicates with the UP/CP Rx upper RLC via an RLC packet data unit (PDU).

21. The HSPA protocol architecture of claim 9 wherein the HSPA NodeB further comprises a legacy NodeB functional layer.

22. The HSPA protocol architecture of claim 9 wherein the HSPA RNC further comprises a legacy RNC functional layer.

23. A high speed packet access (HSPA) protocol architecture, the protocol architecture comprising:
an HSPA NodeB, the HSPA NodeB including a user plane (UP)/control plane (CP) transmit (Tx) lower radio link controller (RLC) functional layer, a UP/CP Tx upper RLC functional layer, a medium access control (MAC) functional layer, and a physical layer;
an HSPA radio network controller (RNC), the HSPA RNC including a radio resource controller (RRC) functional layer, a packet data convergence protocol (PDCP) functional layer, a UP/CP receive (Rx) upper RLC functional layer, a UP/CP Rx lower RLC functional layer, and a physical layer; and
a core network; and wherein
the HSPA NodeB is in communication with the HSPA RNC and the HSPA RNC is in communication with the core network.

24. The HSPA protocol architecture of claim 23 wherein the HSPA NodeB further comprises a legacy NodeB functional layer.

25. The HSPA protocol architecture of claim 23 wherein the HSPA RNC further comprises a legacy RNC functional layer.

26. A high speed packet access (HSPA) protocol architecture, the protocol architecture comprising:
an HSPA NodeB, the HSPA NodeB including a user plane (UP)/control plane (CP) transmit (Tx) lower radio link controller (RLC) functional layer, a UP/CP Tx upper RLC functional layer, a UP/CP receive (Rx) upper RLC functional layer, a UP/CP Rx lower RLC functional layer, a medium access control (MAC) functional layer, and a physical layer;
an HSPA radio network controller (RNC), the HSPA RNC including a radio resource controller (RRC) functional layer, a packet data convergence protocol (PDCP) functional layer, and a physical layer; and
a core network; and wherein
the HSPA NodeB is in communication with the HSPA RNC and the HSPA RNC is in communication with the core network.

27. The HSPA protocol architecture of claim 26 wherein the HSPA NodeB further comprises a legacy NodeB functional layer.

28. The HSPA protocol architecture of claim 26 wherein the HSPA RNC further comprises a legacy RNC functional layer.

29. A high speed packet access (HSPA) protocol architecture, the protocol architecture comprising:
an HSPA NodeB, the HSPA NodeB including a user plane (UP) transmit (Tx) lower radio link controller (RLC) functional layer, a UP Tx upper RLC functional layer, a UP receive (Rx) upper RLC functional layer, a UP Rx lower RLC functional layer, a UP/CP medium access control (MAC) functional layer, and a physical layer;
an HSPA radio network controller (RNC), the HSPA RNC including a radio resource controller (RRC) functional layer, a control plane (CP) Tx lower radio link RLC functional layer, a CP Tx upper RLC functional layer, a CP Rx upper RLC functional layer, a CP Rx lower RLC functional layer a packet data convergence protocol (PDCP) functional layer, and a physical layer; and
a core network; and wherein
the HSPA NodeB is in communication with the HSPA RNC and the HSPA RNC is in communication with the core network.

30. The HSPA protocol architecture of claim 29 wherein the HSPA NodeB further comprises a legacy NodeB functional layer.

31. The HSPA protocol architecture of claim 29 wherein the HSPA RNC further comprises a legacy RNC functional layer.

32. A high speed packet access (HSPA) NodeB, the HSPA NodeB comprising:
a receiver;
a transmitter; and
a processor in communication with the receiver, the processor configured to perform any one of the following functions: segmentation, concatenation, error detection, hybrid automatic repeat request (HARQ) assisted ARQ, error recovery, reassembly, and intra-cell macro-diversity.

33. The HSPA NodeB of claim 32 wherein the processor is further configured to perform any one of the following functions: duplicate detection, in sequence delivery, and full macro-diversity.

34. The HSPA NodeB of claim 32 wherein the processor is further configured to perform macro-diversity.

35. The HSPA NodeB of claim 32 wherein the processor is further configured to perform any one of the following functions: header compression, data transfer, and ciphering.

36. A high speed packet access (HSPA) radio network controller (RNC), the HSPA RNC comprising:
a receiver;
a transmitter; and
a processor, the processor configured to perform any one of the following functions: duplicate detection, in sequence delivery, and full macro-diversity.

37. The HSPA RNC of claim 36 wherein the processor is further configured to perform any one of the following functions: header compression, data transfer, and ciphering.

38. The HSPA RNC of claim 36 wherein the processor is further configured to perform reassembly.

39. The HSPA RNC of claim 36 wherein the processor is further configured to perform any one of the following functions: connection, mobility, and measurement.
